(19) United States
(12) Patent Application Publication
(10) Pub. No.: US 2023/0338907 A1
(43) Pub. Date: Oct. 26, 2023

(54) DEVICE FOR FORMING A FOAM FROM A CLEANING FLUID FOR A CLEANING SYSTEM

(71) Applicant: VALEO SYSTEMES D'ESSUYAGE, La Verriere (FR)

(72) Inventors: Frederic BRETAGNOL, La Verriere (FR); Adrien PERET, La Verriere (FR); Vincent IZABEL, La Verriere (FR)

(73) Assignee: VALEO SYSTEMES D'ESSUYAGE, La Verriere (FR)

(21) Appl. No.: 18/042,711

(22) PCT Filed: Aug. 24, 2021
(86) PCT No.: PCT/EP2021/073341

§ 371 Date: Feb. 23, 2023

(30) Foreign Application Priority Data
Sep. 2, 2020 (FR) FR2008918

(51) Int. Cl. B60S 1/48; B01F 27/118; B01F 23/235; B01F 27/50

(52) U.S. Cl. CPC B01F 23/2351; B01F 27/118; B01F 27/50; B60S 1/481; B01F 2101/24

(57) ABSTRACT

The present invention relates to a device for forming a foam from a cleaning fluid for a wiping system for wiping at least one glazed surface of a vehicle, the device for forming a foam includes at least one cleaning liquid inlet, a chamber intended to receive the cleaning fluid and delimited by a housing, an agitator configured to turn in the chamber about an axis of rotation, a device for driving the agitator, and at least one foam outlet.

### TECHNICAL FIELD

The present invention relates to the field of vehicle cleaning systems. More particularly, the invention relates to devices for forming foam intended to clean notably a glazed surface of a vehicle.

### BACKGROUND OF THE INVENTION

In order to reduce the quantity of washer fluid used, it is also possible to add air in the washer fluid so as to form a foam which will then be sprayed onto the glazed surface. This addition is effected by a pump of the cleaning system from the washer fluid tank.

However, the addition of air in the washer fluid by the pump reduces the longevity thereof. Furthermore, the circulation of the foam in the wiper system as far as the sprinkler increases the cavitation phenomenon within the washer fluid, which may then lead to malfunctions of the pump.

### SUMMARY OF THE INVENTION

The object of the present invention is to at least partially resolve the above problems and to also lead to other advantages by proposing a device for forming a foam from a cleaning fluid for a vehicle cleaning system.

The present invention proposes a device for forming a foam from a cleaning fluid for a wiper system for wiping at least one glazed surface of a vehicle, the foam-forming device comprising at least one cleaning liquid inlet, a chamber intended to receive the cleaning fluid and delimited by a housing, an agitator configured to rotate in the chamber about an axis of rotation, a device for driving the agitator and at least one foam outlet.

Thus when the cleaning fluid circulates in the foam-forming device and while the agitator is driven by the drive device, the agitator, considering its rotational speed within the cleaning fluid, is subjected to a cavitation effect within the cleaning fluid. This cavitation releases the air dissolved in the cleaning fluid. This release then allows air bubbles to form within the cleaning fluid, which will amalgamate to form a foam. Since the foam occupies a greater volume than the cleaning fluid, less cleaning fluid is used while still retaining an optimal cleaning quality of the glazed surface.

According to one embodiment, the drive device comprises at least one electric motor and a shaft connecting the electric motor to the agitator.

According to one embodiment, the device for driving the agitator comprises at least one cleaning fluid-circulating device and a shaft connecting a rotary component of the cleaning fluid-circulating device to the agitator.

According to one embodiment, the drive device comprises at least one turbine configured to be driven by the cleaning fluid circulating in the cleaning system and a shaft connecting the turbine to the agitator.

According to one embodiment, the drive device comprises a cavity in which the turbine is disposed, a wall delimiting the cavity, the cavity and the chamber being in hydraulic communication, the cleaning fluid inlet being arranged on the wall delimiting the cavity, and the fluid outlet being arranged on the housing.

According to one embodiment, the chamber is at least partially delimited by a cylindrical housing in which the agitator is arranged, the cleaning fluid inlet and the foam outlet being arranged circumferentially on the cylindrical housing.

According to one embodiment, the cleaning fluid inlet extends along a main extension direction substantially perpendicular, preferably strictly perpendicular, to the axis of rotation of the agitator and the foam outlet extends along a general extension direction substantially perpendicular, preferably strictly perpendicular, to the axis of rotation of the agitator, the main extension direction and the general extension direction are substantially parallel.

Here, and throughout the following text, the term “substantially” should be understood to mean that production tolerances, and any assembly tolerances, need to be taken into account.

According to one embodiment, the cleaning fluid inlet extends along a main extension direction substantially perpendicular, preferably strictly perpendicular, to the axis of rotation of the agitator and the foam outlet extends along a general extension direction substantially parallel to the axis of rotation of the agitator.

According to one embodiment, the foam outlet is disposed vertically above the cleaning fluid inlet. In other words, the distance between the foam outlet and the cleaning fluid inlet is a non-zero distance, the distance being a length separating the projection of the foam outlet along a vertical axis and the projection of the cleaning liquid inlet along the same vertical axis.

According to one embodiment, the cleaning fluid inlet is disposed vertically above the foam outlet. In other words, the distance between the foam outlet and the cleaning fluid inlet is a non-zero distance, the distance being a length separating the projection of the foam outlet along a vertical axis and the projection of the cleaning liquid inlet along the same vertical axis.

According to one embodiment, the chamber does not have an air inlet.

According to one embodiment, the agitator comprises, at its periphery, a toroidal coil.

According to one embodiment, the drive device is configured to generate a rotational speed of the agitator of between 9000 and 11000 rpm, preferably substantially equal to 10000 rpm.

According to one embodiment, the invention also provides a wiper system for wiping at least one glazed surface of a vehicle, comprising at least one foam-forming device according to the invention, a tank, a cleaning fluid contained in the tank, a network of ducts for channeling the cleaning fluid and/or the foam as far as at least one spray device and a device for circulating the fluid within the network of ducts.

Advantageously, the foam-forming device may be disposed in the vicinity of the spray device. Here, and throughout the following text, the expression “in the vicinity of” should be understood to mean that the distance between the spray device and the foam device is less than or equal to 50 mm, preferably 20 mm.

It is thus possible to spray foams with low stability. In other words, it is possible to spray foams even if the bubbles constituting the foam burst rapidly after their formation. This also makes it possible to avoid excessive pressure drops in the network of ducts.

As the foam-forming device has a closed structure apart from said at least one cleaning liquid inlet and said at least one foam outlet, said forming device is not exposed to any problems of leakage or backflow and may therefore also be disposed at a location remote from the spray device so as to advantageously obtain greater design flexibility.

According to one embodiment, the foam is formed by the agitator from the cleaning fluid and from air bubbles resulting from the air dissolved in the cleaning fluid.

According to one embodiment, the cleaning fluid comprises at least one surfactant.

According to one embodiment, the proportion of surfactant in the cleaning fluid is less than or equal to 0.3% by weight with respect to the total weight of the cleaning fluid.

According to one embodiment, the invention also provides a vehicle comprising at least one glazed surface and a wiper system according to the invention, the wiper system being configured to clean the glazed surface.

The object of the invention is a blower device comprising: a motor holder; a motor housed within the motor holder; a blower fan coupled to the motor; an electronic circuit adapted to control the motor; wherein the motor holder includes an air inlet and an air channel configured to supply the electronic circuit and the motor with an airflow from the air inlet, wherein the air channel includes a first deflector wall and a first liquid trap wall arranged in series between the air inlet and the electronic circuit, wherein the first deflector wall and the first liquid trap wall extend in opposite directions and form a meandering path for the airflow.

### BRIEF DESCRIPTION OF DRAWINGS

Further features and advantages of the invention will become more clearly apparent both from the following description and from a number of exemplary embodiments, which are given by way of non-limiting indication with reference to the attached schematic drawings, in which:

FIG. 1 is a schematic view of a wiper system comprising a foam-forming device according to a first embodiment.

FIG. 2 is an exploded and perspective schematic view of the foam-forming device in FIG. 1.

FIG. 3 is a schematic view in section along plane XZ of a foam-forming device according to a second embodiment.

FIG. 4 is a schematic view in section along plane XZ of a foam-forming device according to a third embodiment.

### DETAILED DESCRIPTION OF THE INVENTION

It should first of all be noted that, although the figures set out the invention in detail for the implementation thereof, they may of course be used to better define the invention, where appropriate. It should also be noted that, in all of the figures, elements that are similar and/or perform the same function are indicated using the same numbering.

In the following description, a longitudinal, vertical and transverse orientation according to the orientation traditionally used in the automobile industry will be adopted in a non-limiting manner. A direction of a longitudinal axis X, a direction of a transverse axis Y, and a direction of a vertical axis Z are represented by a trihedron (X, Y, Z) in the figures. A horizontal plane is defined as being a plane perpendicular to the vertical axis Z and as comprising the direction of the longitudinal axis X and the direction of the transverse axis Y, a longitudinal plane is defined as being a plane perpendicular to the transverse axis Y and as comprising the direction of the longitudinal axis X and the direction of the vertical axis Z, and a transverse plane is defined as being a plane perpendicular to the longitudinal axis X and as comprising the direction of the transverse axis Y and the direction of the vertical axis Z.

It should also be noted that the arrows F indicated in the drawing indicate an overall flow direction of the cleaning fluid and/or of the foam in the wiper system and more particularly in the foam-forming device according to the invention.

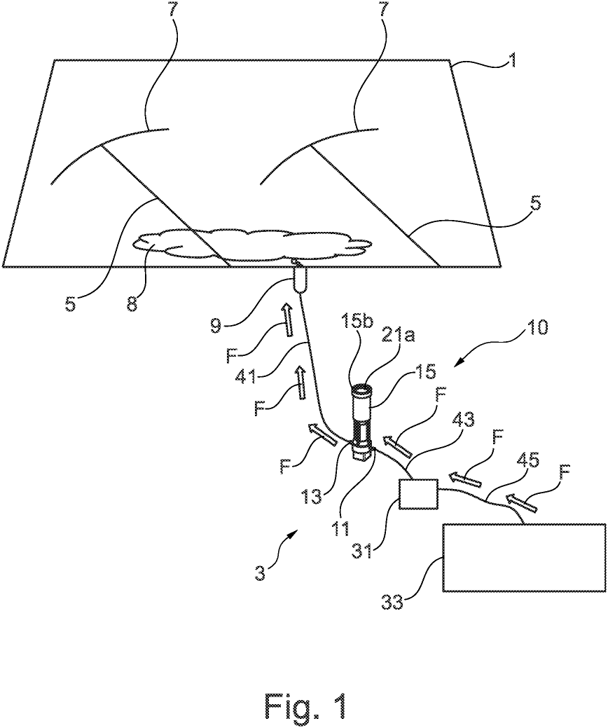

FIG. 1 schematically illustrates a glazed surface 1 of a vehicle, such as a windshield of a vehicle, on which a wiper system 3 for wiping the glazed surface 1 is disposed. The wiper system 3 comprises a wiping device comprising an arm 5 and a wiper blade 7 attached to the arm 5. The wiper blade 7 is in contact with the glazed surface 1. The wiping device further comprises a motor (not shown) configured to cause the wiper blade 7 to move by means of the arm 5 as a function of a command of a user of the vehicle or of a command of a calculation system (not shown) of the vehicle.

With reference to FIG. 1, the wiper system 3 further comprises a spray device 9 arranged on the lower part of the glazed surface 1. The spray device 9 makes it possible to spray a foam 8 onto the glazed surface 1. The spraying of the foam 8 facilitates the cleaning of the glazed surface 1 by the wiper blade 7. The spray device 9 may comprise a plurality of nozzles in order to have a more homogeneous distribution of the foam on the glazed surface 1. The spray device 9 may be, for example, a sprinkler.

In another embodiment that is not shown, the spray device 9 is arranged on a yoke of the wiping device. In another embodiment that is not shown, the spray device 9 is arranged on a spray bar integrated into a structural element of the wiper blade 7.

In the embodiment shown in FIG. 1, the wiper system 3 further comprises a foam-forming device 10 configured to provide the foam 8 to the spray device 9 by way of a hose 41. The hose 41 connects a foam outlet 13 of the foam-forming device 140 to the spray device 9. The foam-forming device 200 makes it possible to produce a foam from a cleaning fluid and the air dissolved in the cleaning fluid.

The foam-forming device 10 is arranged in the vicinity of the spray device 9. Thus a distance between the spray device 9 and the foam-forming device 10 is small in comparison with the dimensions of the vehicle. The distance is substantially equal to 50 mm, for example. It may be less than 50 mm. It is preferably less than or equal to 20 mm. The distance is measured as being the length of the hose 41.

In addition, the wiper system 3 comprises a device 31 for circulating the cleaning fluid stored in a tank 33 of the wiper system 3 toward a cleaning fluid inlet 11 of the foam-forming device 10. The circulating device 31 is, for example, a pump. The circulating device 31 is in hydraulic communication with the cleaning fluid inlet 11 by virtue of a hose 43. The circulating device 31 is in hydraulic communication with the tank as a result of a hose 45.

The hose 41, the hose 43 and the hose 45 form a network of ducts of the cleaning system 3. The network of ducts makes it possible, on the one hand, to channel the cleaning fluid from the tank 33 as far as the foam-forming device 10, and, on the other hand, to channel the foam from the foam-forming device 10 as far as the spray device 9.

The cleaning liquid contained in the tank 33 is a solution comprising 0.3% by mass of solution of a surfactant, that is to say of an amphiphilic molecule capable of modifying the surface tension between two surfaces.

The cleaning liquid is an organic solution, the density of which is less than or equal to 970 kg/m3 for a temperature of between 0° C. and 23° C. The organic solvent used for the organic solution is preferably ethanol. As an alternative, the cleaning liquid may be an aqueous solution, the density of which is greater than or equal to 970 kg/m3 for a temperature of between 0° C. and 23° C.

The foam-forming device 10 according to a first embodiment will now be described in detail.

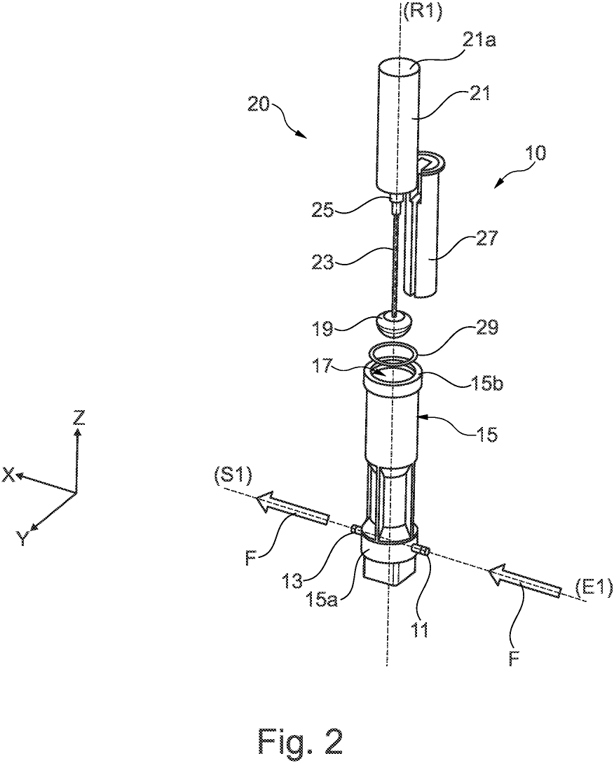

With reference to FIG. 1 and FIG. 2, the foam-forming device 10 comprises a housing 15, the walls of which delimit a chamber 17. The cleaning fluid inlet 11 and the foam outlet 13 are arranged on a lower portion 15a of the housing 15. The housing 15 does not have an air inlet making it possible to bring air into the chamber 17.

The chamber 17 is intended to receive the cleaning fluid conveyed by the circulating device 31 via the cleaning fluid inlet 11. The chamber 17 houses an agitator 19 of the foam-forming device 10. The agitator 19 is configured to rotate in the chamber about an axis of rotation R1. The axis of rotation R1 is parallel to the vertical axis V.

The lower portion 15a of the housing has the shape of a straight cylinder with a circular base developing along the axis of rotation R1 of the agitator 19, the lower portion is equipped with a bottom wall. The lower portion 15a houses the agitator 19. The lower portion 15a is therefore hollow.

The cleaning fluid inlet 11 is arranged circumferentially on the lower portion 15a. In other words, the cleaning fluid inlet 11 develops from a radial end of the lower portion 15a in a main extension direction, away from the chamber 17. The main extension direction defines an axis E1 perpendicular to the axis of rotation R1.

The foam outlet 13 is arranged circumferentially on the lower portion 15a. In other words, the foam outlet 13 develops from a radial end of the lower portion 15a in a general extension direction, opposite to the chamber. The general extension direction defines an axis S1 perpendicular to the axis of rotation R1.

In this first embodiment of the foam-forming device 10, the axis E1 is parallel to and coincident with the axis S1. In other words, the cleaning fluid inlet 11 and the foam outlet 13 are situated at the same level along the vertical axis V.

In addition, the agitator 19 is arranged between the cleaning fluid inlet 11 and 31 the foam outlet 13. In other words, the cleaning fluid inlet 11, the agitator 19 and the foam outlet 13 are aligned along an axis perpendicular to the axis of rotation R1.

In one embodiment that is not shown, the axis E1 and the axis S1 are distinct and secant; moreover, the axis E1 and the axis S1 are contained in a plane perpendicular to the axis of rotation R1.

In the embodiment illustrated in FIGS. 1 and 2, the foam-forming device 10 further comprises a drive device 20 comprising a cassette 21 in which an electric motor configured to be supplied with electrical current by a battery (not shown) of the vehicle is housed, and a shaft 23 protruding from a lower end of the cassette 21 and connecting the electric motor to the agitator 19.

In the remainder of the description, the reference 21 is used both for the cassette and for the electric motor contained in the cassette.

The cassette 21 has the shape of a cylinder with a circular base and developing along the axis of rotation R1, that is to say along the vertical axis Z. The cassette 21 has an upper end 21a which is flush with an upper end 15b of the housing 15.

The electric motor 21 is configured to generate a rotational speed of the agitator 19 of between 9000 and 11000 rpm. Preferably, the rotational speed of the agitator is substantially 10000 rpm.

The shaft 23 is protected against twisting in a zone in which the cassette 21 is passed through by the shaft 23 by a reinforcing element 25.

The shaft 23 is also protected against excessive level of travel by a guide element 27 of the drive device 20. The guide element 27 is inserted around the shaft 23, and between the lower part of the cassette 21 and an upper part of the agitator 19. Preferably, the guide element 27 extends over the entire length of the shaft 23, the length being measured between the lower part of the cassette 21 and an upper part of the agitator 19 along the axis of rotation R1.

At the lower end of the shaft 23, the agitator 19 has the shape of a disk as viewed in a plane perpendicular to the axis of rotation R1, and has the shape of a rectangle with rounded corners as viewed in a plane containing the axis of rotation R1. The diameter of the disk is smaller than the dimensions of the chamber 17 as viewed in a plane perpendicular to the axis of rotation R1. The agitator 19 does not have any oriented elements which would allow it to bear against the cleaning fluid.

The foam-forming device 10 further comprises a toric seal 29 in order to ensure the tightness between the housing 15 and the drive device 20. Thus, any foam 8 and any cleaning fluid can only pass through the foam outlet 13 when the foam-forming device 10 is in operation.

In order to spray the foam 8 onto the glazed surface 1 of the vehicle, the circulating device 31 pumps the cleaning fluid contained in the tank 33 and conveys it in the network of ducts 41, 43, 45 with a given pressure. The cleaning fluid enters the chamber 17 through the cleaning fluid inlet 11. In the chamber 17, the agitator 19 is completely immersed in the cleaning fluid. The rotational speed provided to the agitator 19 by the drive device 20 is substantially equal to 10000 rpm. At this speed, the outer surface of the agitator 19, said outer surface being disposed in the drag of the movement of the cleaning fluid, is subjected to a cavitation effect. The cavitation promotes the appearance of air bubbles resulting from the air dissolved in the cleaning fluid. It should be noted that there is no addition of air coming from ambient air given that the chamber 17 does not have an air inlet and that the agitator 19 remains immersed in the cleaning fluid while it is rotating in the cleaning fluid.

The appearance of air bubbles in the cleaning fluid then gives rise to the formation of the foam 8. The foam 8 is driven by the cleaning fluid toward the foam outlet owing to the pressure imposed by the circulating device 31. The foam 8 and the cleaning fluid are then conveyed to the spray device 9 under the pressure imposed by the circulating device 31 in the duct system. The spray device 9 then disperses the foam 8 and the cleaning fluid on the glazed surface 1 and the wiping device is actuated to clean the glazed surface 1 with the aid of the foam 8.

By way of non-limiting and non-illustrated example, the device for driving the agitator may comprise at least one cleaning fluid-circulating device, in this case for example a water pump for circulating the cleaning liquid.

The water pump comprises a rotary component, in this case for example a turbine and a shaft connecting turbine to the agitator. In other words, when the turbine of the cleaning fluid-circulating device rotates, the agitator connected to the turbine is advantageously operated in a systematic manner.

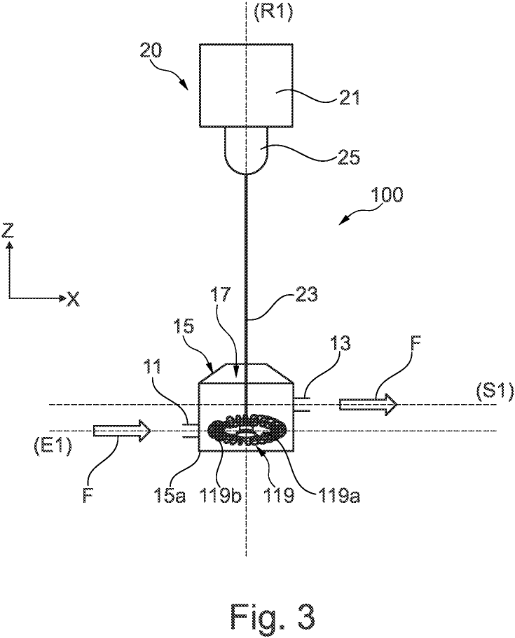

FIG. 3 illustrates a second embodiment of the foam-forming device according the invention. The second embodiment of the foam-forming device 100 is identical to the first embodiment of the foam-forming device 10 described above and shown in FIG. 2, with the exception of the agitator 19 and the positioning of the fluid inlet 11 and of the fluid outlet 13 of the first embodiment. For the elements that are identical, reference can be made to the description of FIG. 2. In addition, the second embodiment of the foam-forming device 100 operates in an identical manner to the first embodiment of the foam-forming device 10 described above.

This second embodiment of the foam-forming device has the advantage of increasing the quantity of foam produced and of improving the effectiveness of the agitator.

With reference to FIG. 3, the cleaning fluid inlet 11 is arranged circumferentially on the lower portion 15a. In other words, the cleaning fluid inlet 11 develops from a radial end of the lower portion 15a in a main extension direction, away from the chamber 17. The main extension direction defines an axis E1 perpendicular to the axis of rotation R1.

The foam outlet 13 is arranged circumferentially on the lower portion 15a. In other words, the foam outlet 13 develops from a radial end of the lower portion 15a in a general extension direction, away from the chamber. The general extension direction defines an axis S1 perpendicular to the axis of rotation R1.

In this second embodiment, the axis E1 is parallel to and distinct from the axis S1 as viewed in a plane containing the radial axis R1. In other words, the cleaning fluid inlet 11 and the foam outlet 13 are situated at different heights measured from the wall of the lower portion 15a and along the vertical axis V, and viewed in a plane containing the axis of rotation R1. In other words, the foam outlet 13 is disposed vertically above the cleaning fluid inlet 11.

In one embodiment that is not shown, the axis E2 and the axis S2 are secant and distinct as viewed in a plane perpendicular to the axis of rotation R1, the foam outlet 13 being disposed vertically above the cleaning fluid inlet 11.

In the embodiment illustrated in FIG. 3, the foam-forming device 100 comprises an agitator 119 fastened to a lower end of the drive shaft 23. The agitator 119 is arranged facing the cleaning fluid inlet 11. The agitator 119 is overall aligned with the cleaning fluid inlet 11 along the axis E1.

The agitator 119 is made up of an annular bearing element 119a and of a toroidal coil 119b. The toroidal coil 119b is fastened to the bearing element 119a. The bearing element 119a is designed as a continuation of the shaft 23 in that the lower end of the shaft has been curved into a ring. The agitator 119 therefore does not have any oriented elements which would allow it to bear against the cleaning fluid. In other words, the agitator is not a propeller.

This second embodiment of the agitator has the advantage of being more effective at forming the foam 8 than the first embodiment. The toroidal shape increases the outer surface of the agitator and increases the cavitation effect on the agitator in the cleaning fluid when the agitator is rotating.

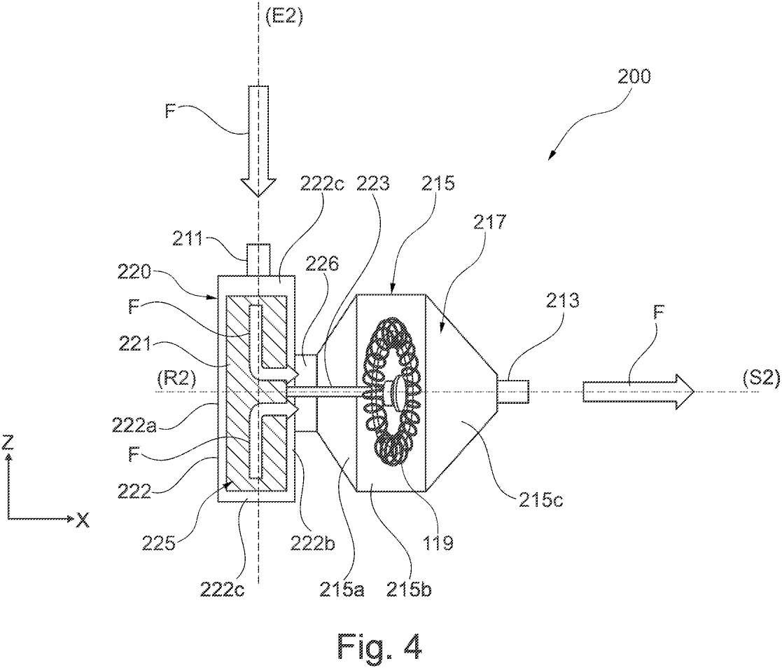

FIG. 4 shows a third embodiment of the foam-forming device according to the invention for the wiper system 3. Thus the third embodiment of the foam-forming device may replace the first embodiment of the foam-forming device in the wiper system 3. This third embodiment has the advantage of using the principle of energy recovery to cause the drive device to move.

With reference to FIG. 4, the foam-forming device 200 comprises a housing 215, the walls of which delimit a chamber 217 intended to receive the cleaning fluid, the agitator 119 configured to rotate in the chamber 217 about an axis of rotation R2 parallel to the longitudinal axis X, and a device 220 for driving the agitator 119. In one embodiment that is not shown, the agitator 119 may be replaced by the agitator 19, that is to say the agitator used in the embodiment shown in FIG. 2.

As illustrated in FIG. 4, the housing 215 comprises a central portion 215b accommodating the agitator 119. The central portion 215b has the shape of a straight cylinder with a circular base developing along the longitudinal axis X. The central portion 215b therefore comprises a first end and a second end opposite to the first end with respect to the longitudinal axis X. The central portion 215b is extended by a first portion 215a at the first end and is extended by a second portion 215c at the second end. The central portion 215b is therefore sandwiched by the first portion 215a and the second portion 215c.

The first portion 215a has a frustoconical shape developing from the central portion 215b toward the side opposite to the central portion 215b along the longitudinal axis X. The first portion 215a comprises a large base, the diameter of which corresponds to the diameter of the central portion 215b, and a small base, the diameter of which is smaller than the diameter of the large base, the large base and the small base being opposite with respect to the longitudinal axis X. The diameters are viewed in a plane perpendicular to the longitudinal axis X.

The second portion 215c has a frustoconical shape developing from the central portion 215b toward the side opposite to the central portion 215b along the longitudinal axis X. The second portion 215c comprises a large base, the diameter of which corresponds to the diameter of the central portion 215b, and a small base, the diameter of which is smaller than the diameter of the large base, the large base and the small base being opposite with respect to the longitudinal axis X. The diameters are viewed in a plane perpendicular to the longitudinal axis X.

Furthermore, the foam-forming device 200 comprises a foam outlet 213. The foam outlet 213 extends the second portion 215c at the small base of the second portion 215c. The foam outlet 13 develops from the small base of the second portion 215c in a general extension direction, away from the central portion 215b. The general extension direction defines an axis S2 parallel to the longitudinal axis X.

The central portion 215a, the first portion 215b, and the second portion 215c are hollow and form the walls of the housing that delimit the chamber 217.

As illustrated in FIG. 4, the device 220 for driving the agitator 119 comprises a turbine 221 housed in a cavity 225 delimited by the walls of a box 222, and a shaft 223 connecting the turbine to the agitator 219. The shaft 223 develops parallel to the longitudinal axis X.

The walls of the box 222 comprise a first transverse wall 222a and a second transverse wall 222b, and a lateral wall 222c connecting the first transverse wall 222a to the second transverse wall 222b. The first transverse wall 222a develops in a plane perpendicular to the longitudinal axis X.

The second transverse wall 222b develops in a plane perpendicular to the longitudinal axis X. The second transverse wall 222b comprises an orifice making it possible to bring the cavity 225 and the chamber 217 into hydraulic communication. The orifice in the second transverse wall 222b is connected to the small base of the first portion 215a of the housing 215 by way of a connecting element 226.

The turbine 221 housed in the cavity 225 is configured to be driven by the cleaning fluid circulating in the network of ducts of the cleaning system 3. Thus the turbine recovers the energy of the cleaning fluid circulating in the duct system. The turbine 221 is configured to generate a rotational speed of the agitator 119 of between 9000 and 11000 rpm. Preferably, the rotational speed of the agitator 119 is substantially 10000 rpm.

The turbine is a propeller comprising a hub connected to the shaft 223 and a plurality of blades. Each blade extends radially outward from the hub and the blades are positioned equidistantly around the hub. The blades are oriented in such a way that the cleaning fluid entering the foam-forming device 200 pushes against the blades in order to cause the turbine 221 to move.

The agitator 119 is connected to the hub of the turbine 221 by the shaft 223. In order to connect the hub of the turbine 221 to the agitator 119, the shaft passes through the second transverse wall 222b of the box 222, the connecting element 226 and the first portion 215a of the housing 215.

The foam-forming device 200 comprises a cleaning fluid inlet 211. The cleaning fluid inlet 211 is disposed vertically above the foam outlet 213. The cleaning fluid inlet 211 is arranged on the lateral wall 222c of the box 222. More precisely, the cleaning fluid inlet 11 develops in a main extension direction which defines an axis E2 substantially perpendicular to the axis of rotation R2, from the lateral wall 222c of the box 222 toward the outside of the box 222. The axis E2 is substantially perpendicular to the axis S2. In one embodiment that is not shown, the axis E2 is strictly perpendicular to the axis S2.

A description will now be given of the operation of the cleaning system 3 using the third embodiment of the foam-forming device 200.

In order to spray the foam 8 onto the glazed surface 1 of the vehicle, the circulating device 31 pumps the cleaning fluid contained in the tank 33 and conveys it in the network of ducts with a given pressure. The cleaning fluid entering the cavity 225 pushes against the blades and drives the turbine 221. The turbine 221 may then provide the agitator 119 with a rotational speed of substantially equal to 10000 rpm by way of the shaft 223.

Since the cavity 225 and the chamber 217 are in hydraulic communication, the cleaning fluid then passes into the chamber 217 by way of the connecting element 226. In the chamber 217, the agitator 119 therefore has a rotational speed substantially equal to 10000 rpm. At this speed, the outer surface of the agitator 119, said outer surface being disposed in the drag of the movement of the cleaning fluid, is subjected to a cavitation effect. The cavitation promotes the appearance of air bubbles resulting from the air dissolved in the cleaning fluid. It should be noted that there is no addition of air coming from ambient air given that the chamber 217 does not have an air inlet and that the agitator 119 remains immersed in the cleaning fluid while it is rotating in the cleaning fluid.

The appearance of air bubbles in the cleaning fluid then gives rise to the formation of the foam 8. The foam 8 is driven by the cleaning fluid toward the foam outlet owing to the pressure imposed by the circulating device 31. The foam 8 and the cleaning fluid are then conveyed to the spray device 9 under the pressure imposed by the circulating device 31 in the duct system. The spray device 9 then disperses the foam 8 and the cleaning fluid on the glazed surface 1 and the wiping device is actuated to clean the glazed surface 1 with the aid of the foam 8.

Of course, the invention is not limited to the examples that have just been described, and numerous modifications, notably to the orientations of the different elements with respect to one another, may be made to these examples without departing from the scope of the invention.

1. A foam-forming device for forming a foam from a cleaning fluid for a wiper system for wiping at least one glazed surface of a vehicle, the foam-forming device comprising at least one cleaning liquid inlet, a chamber intended to receive the cleaning fluid and delimited by a housing, an agitator configured to rotate in the chamber about an axis of rotation a drive device for driving the agitator and at least one foam outlet.

2. The foam-forming device as claimed in claim 1, wherein the drive device includes at least one electric motor and a shaft connecting the electric motor to the agitator.

3. The foam-forming device as claimed in claim 1, wherein the drive device includes at least one cleaning fluid-circulating device and a shaft connecting a rotary component of the cleaning fluid-circulating device to the agitator.

4. The foam-forming device as claimed in claim 1, wherein the drive device includes at least one turbine configured to be driven by the cleaning fluid circulating in the wiper system and a shaft connecting the turbine to the agitator.

5. The foam-forming device as claimed in claim 4, wherein the drive device includes a cavity in which the turbine is disposed, a wall delimiting the cavity, the cavity and the chamber being in hydraulic communication, the cleaning fluid inlet being arranged on the wall delimiting the cavity, and the fluid outlet being arranged on the housing.

6. The foam-forming device as claimed in claim 1, wherein the chamber is at least partially delimited by a cylindrical housing in which the agitator is arranged, the cleaning fluid inlet and the foam outlet being arranged circumferentially on the cylindrical housing.

7. The foam-forming device as claimed in claim 1, wherein the cleaning fluid inlet extends along a main extension direction substantially perpendicular to the axis of rotation of the agitator and the foam outlet extends along a general extension direction substantially perpendicular to the axis of rotation of the agitator, the main extension direction and the general extension direction are substantially parallel.

8. The foam-forming device as claimed in claim 1, wherein the cleaning fluid inlet extends along a main extension direction substantially perpendicular to the axis of rotation of the agitator and the foam outlet extends along a general extension direction substantially parallel to the axis of rotation of the agitator.

9. The foam-forming device as claimed in claim 1, wherein the foam outlet is disposed vertically above the cleaning fluid inlet.

10. A wiper system for wiping at least one glazed surface of a vehicle, comprising at least one foam-forming device a tank, a cleaning fluid contained in the tank, a network of ducts for channeling the cleaning fluid and/or the foam as far as at least one spray device and a device for circulating the fluid within the network of ducts, with the foam-forming device including at least one cleaning liquid inlet, a chamber intended to receive the cleaning fluid and delimited by a housing, an agitator configured to rotate in the chamber about an axis of rotation, a drive device for driving the agitator and at least one foam outlet.
